(19) United States
(12) Patent Application Publication
(10) Pub. No.: US 2020/0358704 A1
(43) Pub. Date: Nov. 12, 2020

(54) PACKET FORWARDING SYSTEM AND METHOD

(71) Applicant: SATIXFY ISRAEL LTD., Rehovot (IL)

(72) Inventor: Yariv ANAFI, Kerem Maharal (IL)

(21) Appl. No.: 16/960,378

(22) PCT Filed: Jan. 6, 2019
(86) PCT No.: PCT/IL2019/050026

§ 371 Date: Jul. 7, 2020

(30) Foreign Application Priority Data
Jan. 7, 2018 (IL) 256749

(51) Int. Cl. H04L 12/801; H04L 12/851; H04L 12/823; H04L 1/00; H04B 17/336; H04B 7/195

(52) U.S. Cl. CPC H04L 47/14; H04L 47/2441; H04L 47/32; H04B 7/195; H04L 1/0003; H04B 17/336; H04L 47/2425

(57) ABSTRACT

A disclosed gateway system comprises a classification component configured to classify a stream of data packets received by the gateway system into a plurality of groups, each of the groups associated with a respective communication port of a payload system, and a frame constructor configured to construct for each of the groups of classified data packets payload-frames comprising data of the classified data packets and target information indicative of at least the respective communication port associated with the classified data packets. The classification component can be configured to classify the received stream of data packets based on destination tags embedded in said the packets. Also disclosed a regenerative communication system comprising a payload system having a receiver configured to receive the respective payload-frames transmitted from the gateway system, and a switching component configured to direct each of the received payload-frames to the respective communication port of the payload system based on the target information contained therein.

### TECHNOLOGICAL FIELD

The present invention is generally in the field of wireless data communication, and particularly relates to regenerative payload communication systems.

### BACKGROUND

The present application relates to communication systems designed to wirelessly communicate data via relay communication system(s), which in some embodiments can be mounted on a moving platform. The moving platform can be a type of terrestrial craft (e.g., land vehicle, sea craft, or suchlike) and/or a type of celestial or space craft (e.g., aircraft, air/gas balloon, drone, glider, satellite, missile, air or space shuttle, and suchlike). The communication components of the relay communication system are generally referred to herein as the payload. Such communication systems are often referred to as relay systems (also referred to herein as payload system), which can be designed to communicate data between a plurality of mobile or stationary ground stations over a plurality of moving platforms/payloads via gateway systems.

For example, in GEO (geosynchronous/stationary) satellite systems, bent pipe (also known as transparent or non-regenerative) communication schemes are traditionally used to forward communication traffic from a fixed gateway link to a fixed end user link on the forward path, and in a similar way on the return path. However, in the bent pipe communication schemes the functionality of the payload (e.g., repeater or transponder), is limited to demultiplexing, filtering, frequency shifting and amplifying the communication traffic incoming from a gateway, and transmitting the same to the destination ground station, usually over a frequency band different from that of the incoming communication. Accordingly, in the bent pipe communication the payload does not and cannot alter the waveform of the incoming signal (e.g., its bandwidth, modulation scheme or coding scheme) but only shift it in frequency and amplify it.

Gateway systems are typically configured to interface communication between two dissimilar communication systems. Usually, the communication from the gateway to the payload system is performed over a dedicated wireless communication channel having certain specific properties (e.g., base/band frequencies, modulation, encoding, etc.), and the communication from the payload system to other ground stations, and/or other payload systems, is performed over a plurality of dedicated wireless communication channels, each having different specific communication properties. The communication from a gateway system to the payload system over a gateway link is generally referred to herein as the forward uplink communication, and the communication from the payload system to the gateway system, is generally referred to herein as the return downlink communication. Similarly, the communication from the payload system to any other ground station (e.g., end user or a cluster of end users) is referred to as the forward downlink communication, while the communication from the user terminals to the payload system is referred to as return uplink communication.

For the sake of simplicity and brevity the embodiments disclosed herein and illustrated in the figures refer only to the forward link, in which uplink communication traffic is transmitted from the gateway system to the payload system, and the downlink communication traffic is transmitted from the payload system to the end-users' terminals. As would be apparent to those skilled in the art, the same principles disclosed herein for communicating over the forward uplink and downlink channels can be similarly used, mutatis mutandis, to communicate over the return link. Thus, the communication over the return link is not described herein in details.

The gateway system is typically equipped with a large antenna and a strong amplifier, thus the gateway links (uplink and downlink) enjoy better link conditions (higher signal to noise ratio, SNR) than the communication links between the payload system and the end-users (also referred to herein as user links).

More advanced satellite systems can send the communication traffic incoming over the gateway link/uplink to several end-users' links over one or more beams in a fixed or in a flexible grid, using for each of the links mentioned above the waveform parameters (e.g., bandwidth, modulation scheme or coding scheme) adequate for each link conditions. The payload system is required in this case to receive incoming communication traffic over a wireless uplink communication channel/link, extract and process the received data, and transmit it via one or more different downlink communication channels. This communication scheme is known as regenerative communication. For example, in regenerative satellite communication systems, the information bits of the incoming communication are demodulated and decoded in the receive channel of the payload system using the certain specific uplink communication properties, and thereafter encoded and modulated using the certain specific downlink communication properties of the transmit channel.

Typically, the regenerative payload system is required to receive the incoming communication traffic over several uplink receive channels, and to transmit the received data through several transmitting channels/ports. The regenerative payload system thus needs to demodulate and decode the incoming communication traffic, extract and process the received data packets, and then select for each received data packet a suitable transmitting channel/port. This routing process requires substantial increase of processing and memory capabilities at the payload system, increased power consumption, and is significantly prone to traffic congestions. In such routing processes, when a queue becomes too long, data packets are dropped.

However, the regenerative satellite systems currently in use provide limited capabilities and flexibility, in particular since the processing of the incoming traffic, and properly routing it to its intended destination by the payload system in a congestion free manner, requires vast computational efforts, extra hardware and power consumption, which are typically not affordable in standard payload systems.

Particularly, receiving the incoming information bit flows using a first set of certain demodulating and decoding characteristics that are specific to the receiving/uplink channel/link, processing the received data and rearranging/routing it into user-frames each complying with specific other downlink communication properties, queuing user-frames in a congestion free manner for transmission, and thereafter transmitting the user-frames using the specific other downlink communication properties for demodulating and decoding the frames, typically affect the size, weight and power consumption of the payload system. The weight is directly influencing the launching costs, and the power consumption is limited by the capability of the satellite power system including the solar panels and the batteries. Of course, a more capable satellite power system has higher weight and again requires higher launching costs. As power consumption and weight have a great impact on the cost of the payload system choosing a method that is power efficient and that can be implemented with small number of parts/hardware, and hence lighter in weight, is highly important.

It is expected from regenerative payload systems to have complete flexibility of sending communication traffic from any gateway link to any user link, as needed. Another limitation of the payload systems being used nowadays is that the gateway forward channel is limited by the user link budget and does not exhaust the SNR conditions. When implementing the payload over LEO (low earth orbit) satellite constellations, for example, the problem is becoming much more complex. At any given time the satellite has different end users in sight, and thus may, or may not, have the gateway system in sight, which may require to communicate to/from the gateway system through inter satellite links (ISL).

Some solutions known from the patent literature are briefly described below.

US Patent Publication No. 2017/0230105 describes a method for transparent on-board routing of data packets at high bit rate by a telecommunication system comprising an origin transmitting station, a first destination receiving station, a second destination receiving station, and a plurality of at least two satellites. The origin transmitting station segments high bit rate data streams into coded or uncoded packets each having the structure of a coded or uncoded DVB-S2 baseband frame BBFRAME; and the origin transmitting station inserts, for each segmented BBFRAME packet, coded or uncoded, an on-board routing label of a single piece respectively associated with the coded or uncoded BBFRAME packet. The on-board routing label contains an identifier of the destination receiving station associated with the coded BBFRAME packet, out of the first destination receiving station and the second destination receiving station.

US Patent Publication No. 2013/003651 describes a satellite comprising at least one central router, a source terminal and a destination terminal. The source terminal comprises means for transmitting, via the central router, IP packets fragmented into at least one level-2 fragment to the destination terminal to which a destination IP address is allocated. The said central router is composed of a satellite and of a ground router. The satellite comprises means for implementing a switching of the IP packets without reassembling the level-2 fragments sent by the source terminal to the destination terminal, the said fragments comprising a reference to the Destination IP address used as basis for the switching. The ground router comprises means for determining IP routing parameters, the said parameters being transmitted by the ground router to the satellite so as to configure the way in which the switching is carried out by the said satellite.

The system described in US Patent Publication No. 2009/323583 contains an RF demodulator a packet aggregation switching device in communication with the RF demodulator, and at least one packet processing engine in communication with the RF demodulator. The packet aggregation switching device controls communication between the RF demodulator and the packet processing engine. An RF modulator may also be in communication with the packet processing engine along an egress path. The packet aggregation switching device may output traffic into the egress path.

International Patent Publication No. WO 2010/148211 describes systems, methods, devices, and processors for packet clustering and frame formation in ACM systems, where a stream of packets may be received at a gateway. During each cycle, a group of packets from the stream may be fetched according to QoS parameters. The group of packets may be clustered according to modcode to produce a packet list. In some embodiments, packets may be arranged and grouped according to transport steam identifier and modcode to produce a packet list. The packet lists may be clustered sequentially from lower order modcode to higher order modcode.

### GENERAL DESCRIPTION

The present application discloses regenerative payload communication systems configured to provide that the regenerative payload maintains a minimal number of actions, comprising demodulation and re-modulation of the communicated information, and simple lookup table operations for the frames forwarding decisions. The sophisticated algorithms typically requiring heavy processing and/or dedicated hardware, like maintaining users SLA (service level agreement), grouping users on the same beam, and suchlike, are carried out in the embodiments disclosed herein by the gateway system (i.e., in a ground station). This allows efficient system solution where the most power consuming tasks are performed by the gateway system where power consumption and hardware weight are not heavy burdens, while minimizing the processing tasks required at the payload (satellite) system. Embodiments disclosed herein also allow saving in the number of gateway systems needed, since they permit to use the gateway forward link (i.e., the uplink) in higher spectral efficiency, independent of the end-users' links conditions.

The term communication link conditions, or link conditions for short, used herein to refer to various parameters of a communication channel that can be affected by properties of the transmission medium used for the communication. For example, and without being limiting, in some embodiments the communication link conditions are characterized by at least one of the SNR, bandwidth, modulation scheme, and/or coding scheme, used for the data communication/transmission.

The most important requirement for regenerative payload is low power consumption. To achieve low power consumption the best practice is to minimize the functionality of the payload system. A typical satellite network is a controlled network that consists of three main components: the gateway system; the satellite payload system, or several satellite payload systems connected to each other through inter satellite link; and the end-user terminal(s). The present application provides wireless communication schemes wherein functionality of the payload system is minimized by moving majority of tasks typically performed by the payload system to the gateway system. In this way, the payload system, and its various components, can be significantly simplified, to thereby obtain a much more power efficient payload system.

In a broad aspect the present application is directed to a communication system for wirelessly communicating data streams over payload systems (e.g., satellites) and that is configured to significantly reduce and simplify the traffic processing and management tasks typically required by the payload systems, by arranging, and adjusting in certain conditions (padding, splitting), the data packets to be communicated via each payload system at a gateway system (e.g., ground station). The gateway system is configured to aggregate the data/packets received (e.g., via the Internet/ISPs) and determine for each received packet, based on its destination tag (e.g., IP address) the payload/satellite communication port (e.g., beam illuminating one or more users) to be used in the downlink communication. The packets to be communicated over a certain downlink port/beam are arranged in payload-frames (e.g., baseband frames to be sent to the payload system) with downlink communication instructions (also referred to herein as path info tag) about the downlink port to be used, and the encoding and modulation to be used therewith, for transmitting the frame to the end user(s).

When arranging the packets in payload-frames, the gateway system adjusts the content of each payload-frame to comply with the code rate (error correction code rate/forward error correction (FEC) rate) of the uplink communication. For example, some space needs to be reserved in the payload-frames if the uplink code rate of the gateway system is higher than the code rate of the downlink of the specific user(s), since the amount of redundancy bits (i.e., error correction bits or parity bits) in the uplink communication is smaller than the amount of redundancy bits in the downlink communication. Thus, in some embodiments a certain amount of bits of the uplink payload-frame is (zero) padded by the gateway system to reserve sufficient space for the downlink redundancy bits i.e., according to the difference between the two redundancies.

In some embodiments the gateway system is configured to adapt the bit padding process to comply with changes in the communication link conditions, such as, but not limited to, the SNR, that may occur in the uplink and/or downlink communication during operation of the system. Accordingly, if during operation the system requires smaller downlink code rates due to smaller downlink SNR conditions, and/or if greater uplink code rates are to be used due to higher uplink SNR conditions, the amount of padding bits in the respective payload-frames is respectively increased by the gateway system. Similarly, if the downlink code rates are increased due to higher SNR conditions in the downlink, and/or if uplink code rates are decreased due to lower SNR in the uplink, the amount of padding bits in the respective payload-frames is respectively decreased, or not at all required, by the gateway system.

The gateway system can be configured to adjust the amount the bits used in the payload-frames for payload data (also referred to herein as data field i.e., which carries fragment(s) of the data stream received by the gateway) based on changes in the uplink and/or downlink communication conditions (e.g., the SNR). For example, and without being limiting, if due to changes in SNR conditions the uplink code rate becomes smaller than the downlink code rate of certain downlink ports/beams, the gateway system correspondingly reduces the size of the data field in the respective payload-frames to be transmitted over the certain ports/beams, to guarantee that there is sufficient amount of space to accommodate the redundancy bits in these payload-frame.

In some embodiments (e.g., DVB-S2/S2X), the gateway compares the uplink and downlink code rates associated with each payload-frame prepared, and uses the lower code rate to determine the amount of payload data bits the frame can carry i.e., the size of the data field.

The gateway system is further configured to guarantee that each payload-frame thereby prepared is capable of accommodating the payload data bits it needs to carry, the redundancy bits required (FEC+padding bits), and the downlink communication information/tag. In some embodiments the length of the downlink communication information/tag can be of varying lengths (e.g., LEO constellation systems), and the gateway system is thus configured to verify for each prepared payload-frame that the number of bits required for the downlink communication information/tag and for the redundancy bits leaves enough space for the payload data bits, for example, as follows:

#Data-Bits≤LEN(PLF)×MIN(UPcode-rate,DOWNcode-rate)−LEN(Tag)

where ‘#Data-Bits’ is the number of payload data bits, ‘LEN(PLF)’ returns the total number of bits available in the payload-frame, MIN(UPcode-rate,DOWNcode-rate) receives the uplink and downlink code rates and returns the smaller code rate, and LEN(Tag) returns the number of bits required for the downlink communication information/tag(s). If this condition is not satisfied, then the gateway system adjusts the size of payload data i.e., #Data-Bits accordingly, to guarantee that sufficient space is reserved in the payload-frame for all of the other fields of the frame.

In order to prevent an overload at the ports/beams of the payload system, there are time periods in which the gateway system cannot send any data to any of the ports/beams of the payload system. The gateway system can be thus configured in some embodiments to send dummy (empty) payload-frames in such time periods for preventing congestions at any of the ports/beams of the payload/satellite system, and thereby match between the throughputs of the uplink and of the ports/beams. The gateway system is configured to send the dummy payload-frames, that are terminated at the demodulator payload system, at some rate actively determined during operation of the system for filling the time/throughput on the gateway uplink without consuming any time/throughput in any of the downlink ports/beams, by guaranteeing that [UPLINK THROUGHPUT]≤Σ[BEAMS/PORTS THROUGHPUT]. In this way, the dummy payload-frame guarantees that continuous and uninterrupted communication of payload-frames in the uplink is maintained without causing traffic congestions at the payload/satellite system.

In some embodiments the payload/satellite system receiving the payload-frames, prepared at the gateway system as described hereinabove, is only required to demodulate and encode the received communication according to the uplink communication parameters, extract and remove the downlink communication instructions/tag(s), decode the payload data of the received payload-frame (thereby replacing some or all of the padded bits with downlink FEC bits), modulate it according to the extracted downlink communication instructions, and transmit the constructed frame via the downlink port indicated in the downlink communication instructions/tag.

In case the payload is capable of transmitting the received communication traffic directly to the end-user(s), all of the downlink communication instructions/tag(s) are removed in the frame construction process performed by the payload system to thereby yield a user-frame comprising the packet(s) data bits received from the gateway system and the downlink FEC bits. If, however, the received communication traffic needs to be transferred to one or more other payload systems (e.g., another satellite in a LEO constellation) before it can reach the destined end-user(s), the payload system removes only a portion of the downlink communication instructions/tag(s) relating to the specific port/beam to be thereby used to forward the communication traffic to the next payload system, and leaves intact all other downlink communication instructions/tag(s), to thereby obtain a new payload-frame to be transmitted to the next payload system in the transmission chain determined at the gateway system for the specific end-user(s).

The gateway system can be also configured to prevent congestions at the payload/satellite system by verifying that the uplink communication data rate is at all times smaller than, or equal to, the sum of the data rates to be transmitted via the downlink communication ports of the payload system.

This communication scheme substantially simplifies the operation and design of the payload/satellite communication system, since it is not required to carry out the actual IP routing tasks, thereby improving the communication speed, reducing power consumption and hardware costs and weight, and improving spectral efficiency.

Decoupling between the uplink and downlink communication conditions, achieved in some embodiments by decoupling the user downlink SNR conditions and the SNR conditions of the gateway uplink, enables using the gateway link in much higher spectral efficiency, which directly translates into saving in the number of gateway systems needed.

For example, in embodiments disclosed herein the forward uplink channel of the gateway system is configured to manage substantially all of the parameters affecting the communication traffic, such as, but not limited to, service level agreement (SLA) of each end-user(s), the actual required bandwidth demand of each end-user(s), location of each end user(s) at any instant of time, which payload/satellite beam illuminates the end-user(s), and uplink and downlink SNR conditions. Based on all of this information the gateway system can arrange the communication traffic into payload-frames configured to substantially simplify the construction of user-frames, and/or further payload-frames, by the payload system. For example, if the gateway system sends just enough communication traffic to each end-user in such a way that there is no congestion point in the payload system, the payload system does not handle long queues and frame transmission scheduling. This significantly simplifies the payload system and removes the need for mounting power consuming logic thereon.

One inventive aspect of the subject matter disclosed herein is directed to a gateway system comprising a classification component configured to classify a stream of data packets received by the gateway system into a plurality of groups, each of the groups associated with a respective communication port of a payload system, and a frame constructor configured to construct for each of the groups of classified data packets payload-frames comprising data of the classified data packets and target information indicative of at least the respective communication port associated with the classified data packets. The classification component can be configured to classify the received stream of data packets based on destination tags embedded in said the packets.

The frame constructor is configured in some embodiments to determine the amount of the classified data packets carried by at least one of the payload-frames based at least in part on a code rate associated with its respective communication port. Particularly, the frame constructor can be configured to determine for the respective payload-frames of each of the plurality of groups an amount of the classified data packets based at least in part on communication link conditions associated with the respective communication port of the group, and to construct the respective payload-frames to comprise the determined amount of data of the classified data packets and target information indicative of at least the respective communication port associated with the classified data packets. This way it can be guaranteed that the respective payload-frames can accommodate error correction data to be inserted thereinto by the payload system for transmitting them via the respective communication port. The communication link conditions can comprise at least one of SNR, bandwidth, modulation scheme and/or coding scheme.

Optionally, and in some embodiment preferably, the frame constructor is configured and operable to construct one or more dummy frames during time periods in which communication of data packets associated with one or more of the communication ports of the payload system is stopped. The dummy frames constructed by the frame constructor do not include packet data, and preferably do not include any meaningful/valuable data.

A control unit can be used in some embodiments to determine a size of a data field of the payload-frames based at least in part on the communication link conditions, such as, but not limited to the signal-to-noise conditions, in a communication channel between the gateway and the payload system. Optionally, and in some embodiments preferably, the control unit of the gateway system is configured and operable to determine a size of an error correction data field of each of the payload-frames based at least in part on the communication link conditions (e.g., based on a signal-to-noise ratio of the communication link). The control unit of the gateway system can be configured and operable to reserve a portion of the error correction data field for error correction code data associated with the respective communication port of the payload system.

The gateway system comprises in some embodiments a communication component configured to transmit the payload-frames to the payload system. The control unit of the gateway system can be configured and operable to determine at least one of a code rate and modulation properties for the transmission by the communication component of the gateway system based at least in part on the communication link (e.g., the signal-to-noise ratio) conditions.

The above described gateway system can be used in a regenerative communication system comprising a payload system having a receiver configured to receive the payload-frames transmitted from the gateway system, and a switching component configured to direct each of the received payload-frames to the respective communication port of the payload system based on the target information contained therein. The receiver of the payload system can be configured to discard the dummy frames received from the gateway system.

The payload system comprises in some embodiments a communication component configured to transmit each received payload-frame via its respective communication port. The control unit of the gateway system can be configured to determine at least one of a code rate and modulation properties used by the communication component of the payload system to transmit the payload-frames.

Optionally, and in some embodiments preferably, the payload system is configured and operable to transform one or more of the payload-frames received from the gateway system into user-frames by placing in the error correction code data field of each of the payload-frames error correction code data associated with the respective communication port, and removing at least a portion of the target information associated with the respective communication port. The transmission of the frames from the payload system can be different from the transmission from the gateway system by at least one of modulation and coding scheme. Additionally or alternatively, the transmission of the frames from the payload system is different from the transmission from the gateway system by at least one of a center frequency and a frequency band.

In some embodiments the gateway system comprises a scheduler configured and operable to determine a sequence of the payload-frames directed to the different communication ports for transmission to the payload system. The scheduler can be configured and operable to determine the sequence of the payload-frames to be transmitted to the payload system based at least in part on a service level agreement of at least one end-user associated with one of the communication ports. Optionally, the scheduler is configured and operable to determine the sequence of the payload-frames based at least in part on a throughput of at least one of the communication ports. The scheduler is configured and operable in some embodiment to guarantee that a transmission rate of the payload-frames from the gateway system is smaller than, or equal to, a total frame transmission rate from all of communication ports of the payload system.

In possible applications the payload system is either a terrestrial craft, celestial or space craft. Optionally, and in some embodiments preferably, the payload system is one of the following: aircraft, air/gas balloon, satellite, missile, air or space shuttle.

Another inventive aspect of the subject matter disclosed herein relates to a method of forwarding data packets, the method comprising classifying a stream of data packets into a plurality of groups, each of the groups associated with a respective communication port of a payload system, and for each of the groups constructing at least one payload-frame comprising data of the classified data packets and target information indicative of at least the respective communication port associated with the classified data packets. The classifying of the stream of data packets into a plurality of groups can be based on destination tags embedded in the data packets. The constructing comprises in some embodiments determining the amount of the classified data packets carried by at least one of the payload-frames based at least in part on a code rate associated with its respective communication port.

Particularly, for each of the groups an amount of the classified data packets carried by respective payload-frames is determined based at least in part on communication link conditions associated with the respective communication port of the group. The respective payload-frames are accordingly constructed to comprise the determined amount of the classified data packets, and target information indicative of at least the respective communication port associated with the classified data packets. This way it can be guaranteed that the respective payload-frames can accommodate error correction data to be inserted thereinto by the payload system.

The method can comprise constructing one or more dummy frames during time periods in which communication of data packets associated with one or more of the communication ports of the payload system is stopped. The constructed dummy frames preferably do not include any meaningful/valuable data.

The method comprises in some embodiments determining a size of a data field of each of the payload-frames based at least in part on the communication link conditions, such as, but not limited to, the signal-to-noise conditions, in a communication channel associated with the payload system. The method can comprise determining a size of an error correction data field of each of the respective payload-frames based at least in part on the communication link (e.g., the signal-to-noise ratio) conditions. Optionally, and in some embodiments preferably, the method comprises reserving a portion of the error correction data field for error correction code data associated with the respective communication port of the payload system.

The method can further comprise transmitting the payload-frames to the payload system. The method can comprise determining at least one of a code rate and modulation properties for the transmission to the payload system based at least in part on the communication link (e.g., signal-to-noise ratio) conditions. Thus, the method can further comprise receiving the respective payload-frames at the payload system and directing each of the received respective payload-frames to the respective communication port of the payload system based on the target information contained therein. Optionally, and in some embodiments preferably, the receiving of the respective payload-frames at the payload system comprises discarding the dummy frames.

In some embodiments the method comprises transmitting each of the received respective payload-frames via its respective communication port. The method can further comprise determining at least one of a code rate and modulation properties used for the transmitting via the respective communication port. The method comprises in some embodiment placing in the error correction code data field of each of the payload-frames error correction code data associated with the respective communication port, and removing therefrom at least a portion of the target information associated with the respective communication port.

The method comprises in some embodiments determining a sequence of the respective payload-frames for transmission to the payload system based at least in part on a service level agreement of at least one end-user associated with one of the communication ports. The determining of the sequence of the respective payload-frames is based in some embodiments at least in part on a throughput of at least one of the communication ports. Optionally, and in some embodiment preferably, the determining of the sequence of the respective payload-frames comprises guaranteeing that a transmission rate of the payload-frames to the payload system is smaller than, or equal to, a total frame transmission rate from all of the communication ports of the payload system.

Yet another inventive aspect disclosed herein relates to a payload communication system configured to place in an error correction code data field of payload-frames thereby received error correction code data associated with a communication port of the payload system, as described hereinabove and hereinbelow, and illustrated in the drawings. The error correction code data field of the received payload-frames can at least partially accommodate error correction code data generated by the transmitter/gateway system, so the payload system can be configured to place the error correction code data associated with the communication port of the payload system in the portion of the error correction code data field occupied by error correction code data generated by the transmitter/gateway system, and/or in a reserved portion of the error correction code data field of the payload-frames. Optionally, but in some embodiments preferably, the payload system is configured to remove at least a portion of a target information residing in the payload-frames and associated with the respective communication port, so the error correction code data associated with the communication port of the payload system can be at least partially accommodated in the portion of the payload-frame from which the target information was removed.

Yet another inventive aspect disclosed herein relates to a gateway communication system configured to determine a sequence of payload-frames for transmission to a payload system based at least in part on a throughput of at least one of the communication ports of the payload system, as described hereinabove and hereinbelow, and illustrated in the drawings.

Yet another inventive aspect disclosed herein relates to a gateway communication system configured to guarantee that a transmission rate of payload-frames thereby transmitted is smaller than, or equal to, a total frame transmission rate from all of the communication ports of the payload system, as described hereinabove and hereinbelow, and illustrated in the drawings.

### BRIEF DESCRIPTION OF THE DRAWINGS

In order to understand the invention and to see how it may be carried out in practice, embodiments will now be described, by way of non-limiting example only, with reference to the accompanying drawings. Features shown in the drawings are meant to be illustrative of only some embodiments of the invention, unless otherwise implicitly indicated. In the drawings like reference numerals are used to indicate corresponding parts, and in which:

FIGS. 1A and 1B schematically illustrate packet forwarding systems wherein FIG. 1A shows a bent pipe communication system and FIG. 1B shows a system for forwarding communication traffic according to some possible embodiments;

FIGS. 2A and 2B respectively show a flow chart and a block diagram schematically illustrating forwarding of communication traffic over a payload system according to some possible embodiments;

FIGS. 3A and 3B schematically illustrate components of a gateway system according to some possible embodiments, wherein FIG. 3A is a block diagram of a possible gateway system, and FIG. 3B is a block diagram illustrating a possible payload-frames scheduler usable in the gateway system of FIG. 3A;

FIGS. 4A to 4C schematically illustrate structures of payload-frames and user-frames according to some possible embodiments, wherein FIG. 4A shows a payload-frame having a number of downlink communication information tag(s) determined by the gateway system, FIG. 4B shows a payload-frame after removal of a downlink communication information tag and encoding at the payload system, and FIG. 4C shows a user-frame obtained after removal of the last downlink communication information tag and encoding at the last payload system in a payload transmission chain;

FIG. 5 is a flowchart schematically illustrating communication management by a gateway system according to some possible embodiments;

FIG. 6 schematically illustrates a satellite payload system according to some possible embodiments; and

FIG. 7 shows an example table of bandwidths and code rates usable in a satellite payload system as shown in FIG. 6.

### DETAILED DESCRIPTION OF EMBODIMENTS

One or more specific embodiments of the present disclosure will be described below with reference to the drawings, which are to be considered in all aspects as illustrative only and not restrictive in any manner. In an effort to provide a concise description of these embodiments, not all features of an actual implementation are described in the specification. Emphasis being placed upon clearly illustrating the principles of the invention such that persons skilled in the art will be able to make and use the disclosed embodiments, once they understand the principles of the subject matter of this application. The inventive concept disclosed herein may be provided in other specific forms and embodiments without departing from the essential characteristics described herein.

The embodiments described hereinbelow are exemplified in the context of the satellite communication systems utilizing DVB-S2 (or DVB-S2X) standards and IP protocols. It is however noted that such embodiments can be implemented in various different wireless payload communication systems, utilizing other data communication standards and protocols, without departing from the scope and spirit of the present invention.

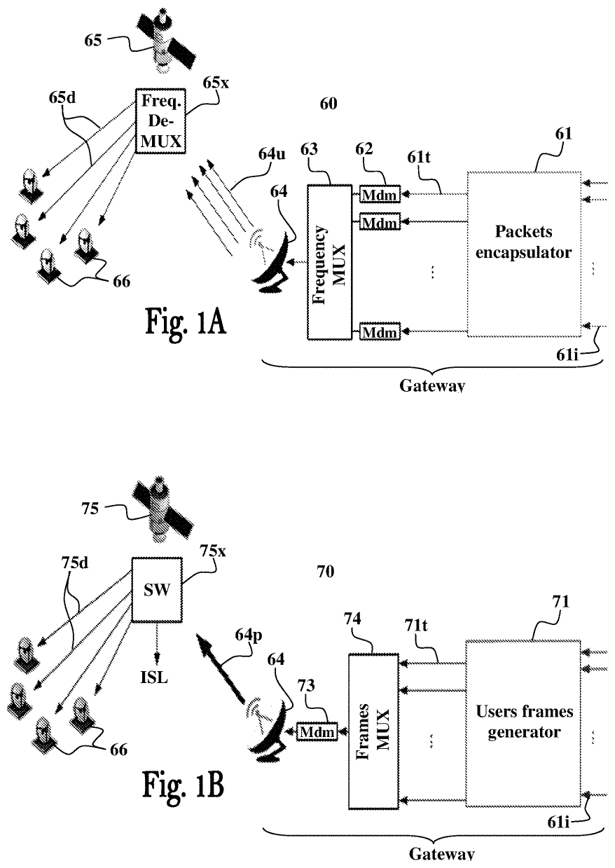

FIG. 1A exemplifies a bent pipe communication system 60, wherein the communication schemes (MODCOD) used for the uplink 64u, between the gateway and the payload 65, and the communication scheme used for the downlink 65d, between the payload 65 and end users 66, are substantially the same. In this example, the incoming communication traffic 611 received from a plurality of sources is routed and arranged into frames by the packet encapsulator 61, and a respective modem 62 is used for modulating the frames 61t destined to a specific user (or group of users)/address 66. The modulated frames are transmitted over the uplink 64u by the transmitter 64 after frequency multiplexing 63, and after frequency demultiplexing 65x they are transmitted from the payload 65 to the users 66. Such bent pipe communication systems 60 are typically characterized by low spectral efficiency in the uplink 64u, since more bandwidth is required in the uplink communication than actually necessary, which thus requires utilization of greater number of gateway systems.

Flexibility and decoupling of wireless payload communication systems can be achieved using standard routers e.g., such as IP (internet protocol) routers, mounted for operation on the payload system. The incoming communication traffic (611) in the forward channel, destined to the different end-users (66), is typically in a form of data packets (e.g., IP packets) that need to be transferred to the end-users (66). Each data packet typically comprises the IP address of the end-user to which it is destined as part of the data to be transferred, and the data packets are sent in data frames to the payload (65) using a first communication scheme (MODCOD). The payload extracts and rearranges the data packets in new data frames and sends them to the end-users (66) using a second communication scheme that is different than the first communication scheme.

Particularly, the data packets received in the incoming communication traffic are aggregated in the gateway system into a stream of data packets arranged into data frames (e.g., baseband frames or BBFRAMES according to the DVB-S2/S2X specification, generated by packets encapsulator), each containing a given number of bits, according, for example, to the DVB-S2/S2X transmission protocol, which is suitable for uplink transmission to the payload (satellite) systems, according to modulation and coding (MODCODgw) scheme adequate to the gateway-to-payload (gateway-to-satellite—GW-SAT) communication link conditions. The payload system is then required to conduct the following operations:
demodulate and decode the baseband data frames received in the uplink transmission from the gateway system;
process and analyze the received data frames to extract from each IP data packet the IP address of its end-user (i.e., the destination of the packet), and since it is likely that some of the packets are fragmented at the gateway system and sent to the payload system over different data frames, the payload is further required to reconstruct/reassemble the fragmented IP data packets transferred thereto over different data frames, which thus requires additional buffer and memory resources in the payload system;
route each of the extracted/reconstructed data packets (e.g., using an IP router) to a suitable downlink port of the payload system (e.g., a satellite beam);
maintain for each end-user a queue of data packets, perhaps even with priorities according to the service level agreement (SLA) of each particular end-user;
aggregate in each downlink port the data packets destined to each end-user (66) and construct for each end-user the new frames containing the data packets addressed thereto, for transmission over the respective downlink (e.g., satellite-user link); and
encode and modulate the new frames for downlink transmission using modulation and code rate suitable for the payload-user (satellite-user) downlink communication link conditions.

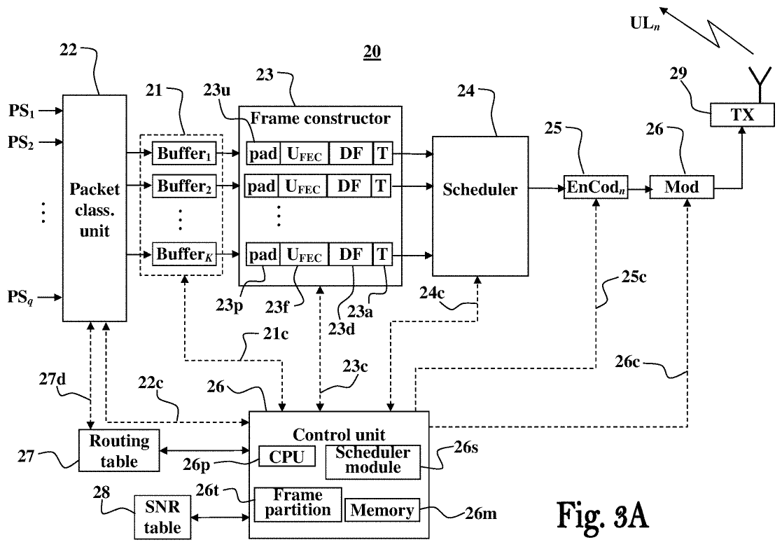

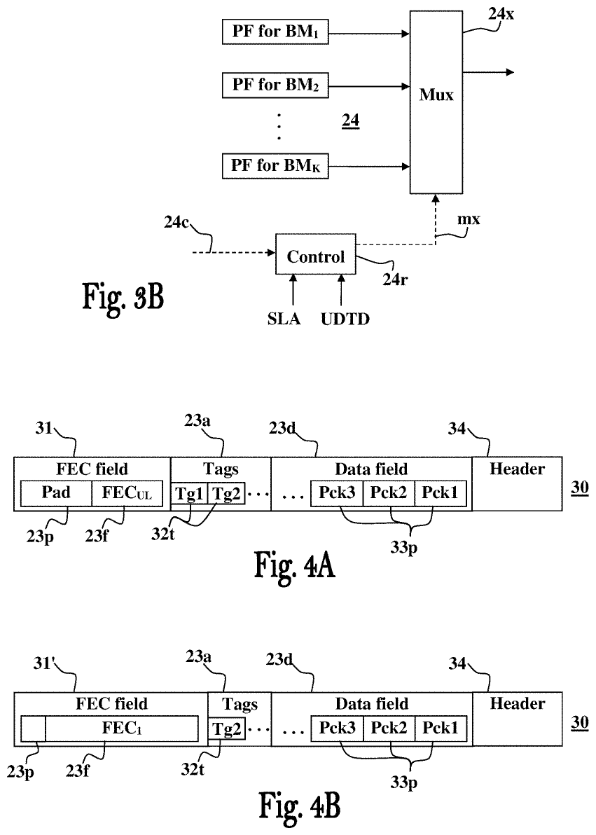

A principal feature of embodiments disclosed herein, as exemplified in FIG. 1B, is to construct the user-frames at the gateway system and configure the payload system 75 to perform switching (75x) of complete baseband frames 71t containing the user's data packets (611), a priory arranged at the gateway system, and to transmit the switched frames to the user terminals 66 over the downlink 75d, and/or to other payload systems via the inter satellite link (ISL e.g., as in LEO satellite system). In this packet forwarding approach same coding with different modulations can be used for the uplink and downlink communication, which substantially reduces the operations carried out by the payload to frame switching and re-modulation. The gateway system of some possible embodiments is thus configured to at least:
route the users' data packets of the incoming communication traffic to aggregating buffers (e.g., is the users frames generator 71), each buffer (shown in FIG. 3A) associated with a respective downlink port (of a respective downlink 75d) of the payload system 75;
construct from the aggregated data packets payload-frames 71t containing the data packets tagged with the end-user's IP address, and downlink (75d) communication instructions/tag(s) to be used at the payload system 75 to convert the payload-frame 71t into a readily transmittable user-frame,
encode and modulate the payload-frames, and schedule (e.g., by multiplexer 74) them for transmission to the payload system 75 via the transmitter 64 using at least one modem 73 (i.e., a single modem can be used transmit the multiplexed frames).

In this way, the burdens associated with the packet processing, user-frames construction, routing, and the scheduling and timely managing of the frames transmission, are moved from the payload system 75 to the gateway system. This way, higher spectral efficiency is obtained over the uplink 64p (e.g., using 256APSK, or higher APSK, modulation scheme), which enables utilization of a smaller number of gateway systems.

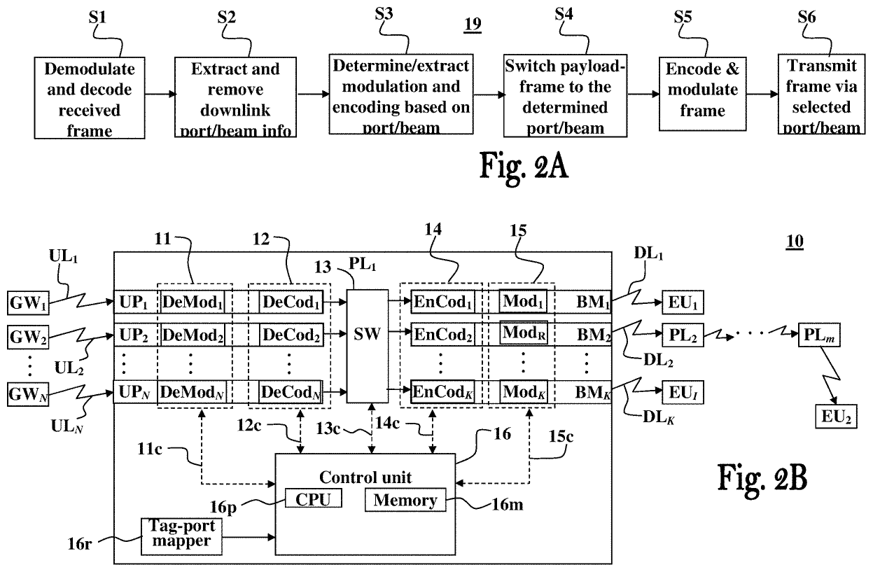

In some embodiments the processing carried out by the payload system comprises the steps illustrated in the flowchart 19 of FIG. 2A. Accordingly, the payload system can be configured to demodulate and decode the payload-frames received via at least one uplink, all the way from samples to a decoded baseband frames, as illustrated in step S1. Next, in step S2, the payload system extracts and removes from each received payload-frame at least one downlink communication instruction/tag, and in step S3 it uses the removed downlink communication instruction/tag to determine a target downlink beam/port to be thereby used for forwarding the frame data over, and the modulation and coding scheme (e.g., MODCOD) to be used for encoding and modulating the frame data on, the determined target downlink beam/port.

In step S4 the payload-frames are switched to the determined port/beam, and in step S5 the payload system encodes each payload-frame to construct a user-frame (or a further payload-frame), that is next modulated for transmission to end-user (or to the next payload system). Each encoded and modulated user-frame (or further payload-frame) is thereafter transmitted in step S6 towards its target destination via the target downlink beam/port determined therefore.

As reflected from FIG. 2A, in such embodiments the payload system is not required to extract and process the packets contained inside the received payload-frames, nor to route, aggregate and manage queues of the user's data packets. Accordingly, the communication scheme 19 described above significantly reduces the processing efforts required in the conventional payload routing systems.

FIG. 2B schematically illustrates a payload communication system 10 usable according to some possible embodiments for wireless communication traffic forwarding. The communication system 10 comprises at least one gateway system GWₙ (where 1≤n≤N is a positive integer) configured to wirelessly communicate with at least one payload system PLₘ (where 1≤m≤M is a positive integer), over a respective at least one uplink channel ULₙ. The at least one payload system PLₘ is configured to wirelessly communicate with at least one end user EUᵢ (where 1≤i≤I is a positive integer), and/or at least one other payload system PL_{q} (where 1≤q≠m≤M is a positive integer), over at least one downlink channel/beam DLₖ (where 1≤k≤K is a positive integer).

A payload system PL₁ in the communication system 10 comprises in some embodiments a control unit 16, a demodulation unit 11, a decoder unit 12, a frame switch device 13 (SW), an encoder unit 14, and a modulation unit 15. The control unit 16 may comprise one or more processing units 16p and memory devices 16m.

The payload system PL₁ can use for each uplink channel ULₙ a respective uplink port UPₙ configured to receive the communication transmitted over the uplink channel ULₙ, and use in each uplink port UPₙ a respective demodulator DeModₙ of the demodulation unit 11 and a respective decoder DeCodₙ of the decoder unit 12, to demodulate and decode the received communication. The demodulation unit 11 and the control unit 16 can exchange control signals/data 11c for determining demodulation settings (e.g., baseband frequency, band frequency range, etc.) of each demodulator DeModₙ. The decoder unit 12 and the control unit 16 can exchange control signals/data 12c for determining decoding settings of each decoder DeCodₙ (e.g., coding schemes, code rates, and suchlike).

The payload system PL₁ can use for each downlink channel DLₖ a respective downlink port BMₖ (generally referred to herein as a forward communication component of the payload system) configured to receive payload-frames from the switch device 13, and use a respective encoder EnCodₖ of the encoder unit 14 and a respective modulator Modₖ of the modulation unit 15, to encode and modulate the switched payload-frames for transmission over their respective downlink ports/beams DL₄. The encoder unit 14 and the control unit 16 can exchange control signals/data 14c for determining coding settings of each encoder EnCod₄ (e.g., coding schemes, code rates, and suchlike). The modulation unit 15 and the control unit 16 can exchange control signals/data 15c for determining modulation settings (e.g., baseband frequency, band frequency range, etc.) of each modulator Modₙ.

In some embodiments the control unit generates control signals/data 15c to instruct the modulation unit 15 to generate a dummy frame by one or more of its modulators Modₖ for transmission via the respective beam/port BMₖ, the control unit 16 can be configured to instruct the modulation unit 15 to generate the dummy frames in case there are no data payload-frames to send via one or more of the beam/port BMₖ, or if the communication traffic via a certain port/beam exceeds the SLA of the end-user(s) associated therewith, which may cause overflow in the payload system PLₘ. In some embodiments the modulation unit 15 is configured to automatically generate the dummy frames by one or more of its modulators Modₖ if there are no data payload-frames to transmit thereby.

The demodulator DeModₙ and decoder DeCodₙ of each uplink port UPₙ generate a stream of payload-frames, each constructed at its respective gateway system GWₙ, which are readily usable for transmission as user-frames, or which can be easily and quickly converted into user-frames, that the payload can forward towards the addressed end-user(s) EUᵢ. Thus, according to some possible embodiments the switch device 13 is configured to direct each payload-frame thereby received through an uplink port UPₙ to a respective downlink port BMₖ based on downlink communication instructions/tag(s) carried by the payload-frame. The switched payload-frames can be then encoded and modulated for transmission over the respective downlink channel/beam, without processing/inspecting the packet data they carry.

The payload system PL₁ e.g., its switch device 13, can be configured to remove the downlink communication instructions/tag(s), or at least some portion thereof, from each payload-frame thereby switched. If the payload-frame can be transmitted by the payload system PL₁ directly to the end-user(s) EUᵢ, then the downlink communication instructions/tag(s) contained in the frame are no longer needed after the switching and can be removed from the frame. The non-occupied downlink communication instructions/tag(s) bits of the frame, or some portion thereof, that has been removed after the switching, can be used to accommodate error correction bits (e.g., FEC/parity bits) that the respective downlink port BMₖ may require in certain situations (e.g., when the code rate of the uplink is smaller than the code rate of the downlink).

In some embodiments, payload-frames received in the payload system PL₁ are forwarded to one or more other payload systems PLₘ (m≠1) in a chain of payload systems determined at their respective gateway systems for transmission towards the addressed end-user(s) EUᵢ. In this case, only the portion of the downlink communication instructions/tag(s) associated with the payload system PL₁ is removed from the frame. In a similar fashion, the non-occupied frame bits of the portion of the downlink communication instructions/tag(s) removed from the frame can be used to accommodate error correction bits, as described above.

In some embodiments the downlink communication instructions/tag(s) contained in the payload-frame is indicative of the addressed end-user(s), and the control unit 16 is configured to determine which downlink port BMₖ is to be used for the transmission of the frame towards the end-user(s). A tag-port mapper unit 16r can be used in such embodiments to determine which downlink port BMₖ is to be used for the transmission of the frame towards its end-user(s), and/or a chain of other payload systems to be used for this purpose. The tag-port mapper unit 16r can use a type of look-up-table configured to receive as input an end-user(s) address, and output a respective downlink port BMₖ, and/or a chain of at least one other payload systems PLₘ (m≠1), to be incorporated in the downlink communication instructions/tag(s) of the frame. The control unit 16 can be configured to include the tag-port mapper unit 16r e.g., as an internal module, or alternatively, it may be configured to be an independent unit configured to communicate signals/data with the control unit 16, and/or the switch device 13. The control unit 16 can be thus configured to exchange signals/data 13c with the switch device 13.

FIG. 3A is a block diagram illustrating a gateway system 20 (GWₙ) according to some possible embodiments. The gateway system 20 comprises a packet classification unit 22 configured and operable to receive at least one stream of packets PS_{q} (where 1≤q≤Q is a positive integer), a buffering unit 21 configured and operable to receive classified/sorted packets from the packet classifying unit 22, a frame constructor 23 configured and operable to construct payload-frames using classified packets from the buffering unit 21, a scheduler 24 configured and operable to schedule transmission of the payload-frames, encoder unit 25 and modulator unit 26 respectively configured and operable to encode and modulate payload-frames scheduled for transmission by the scheduler 24, and a transmitter 29 configured and operable for transmitting the encoded and modulated payload-frames over the uplink channel ULₙ of the gateway system 20. In possible embodiments the buffering unit 21 is integral part of the frame constructor 23.

The packet classification unit 22 can be configured to use a routing table 27 for determining a payload port/beam that can be used to transmit each received data packet towards its destination end-user. The routing table 27 can be integral to the packet classification unit 22, and it can be implemented by a look-up-table configured to receive a destination tag/IP address of a received data packet, and output a respective payload port/beam, or a chain of payload systems and ports/beams thereof, to be used to forward the data packet to its addressed end-user(s). Data/signals 27d can be exchanged between the packet classification unit 22 and the routing table 27. Based on the routing table 27, the packet classification unit 22 transfers each received packet to a respective one of the buffers, Bufferₖ, of the buffering unit 21. Each buffer Bufferₖ in the buffering unit 21 is associated with a respective communication port/beam BMₖ of a payload system PLₘ.

For each buffer Bufferₖ in the buffering unit 21 there is a respective frame constructing component 23u in the frame constructor 23, configured and operable to construct a payload-frame adapted to carry packet(s) data from the buffer Bufferₖ in a data field (DF) 23d thereof, of a determined size. Each constructed payload-frame comprises a header (not shown), a tag field (T) 23a adapted to carry the downlink communication information/tag(s) of the payload-frame, a U_{FEC} field 23f adapted to carry the error correction data for the uplink communication, and optionally a padded portion (pad) 23p reserved for allowing the frame to accommodate downlink error correction data and thereby quick conversion of the payload-frame into a user-frame at the payload system PLₘ.

A control unit 26, comprising one or more processors 26p and memories 26m, can be used to orchestrate different functions of the gateway system 20. For example, and without being limiting, control signals/data 21c can be generated by the control unit 26 for managing the operation of the buffering unit 21. The control unit 26 can be further configured to generate control signals/data 25c for managing the operation of the encoder 25, and/or control signals/data 26c for managing the operation of the modulator 26.

Control signals/data 22c can be exchanged between the packet classification unit 22 and the control unit 26 for adapting the classification operations to changes that may occur at the payload system PLₘ e.g., which end-users can be communicated through certain ports/beams at any given point of time. Data can be exchanged between the routing table 27 and the control unit 26 to update the routing table about possible changes, that may occur from time to time, in the port/beam coverage of the payload system PLₘ. Signals/data 22c the control unit 26 exchange with the packet classification unit 22, and/or 27d the routing table 27 exchanges with the packet classification unit 22, can be used to periodically/intermittently update the control unit 26 about the packet classification statistics/history reported by the packet classification unit 22.

The control unit 26 can be configured and operable to periodically/intermittently determine the sizes of each field in the payload-frames constructed by the frame constructor 23 for each communication port/beam BMₖ of the payload system PLₘ, and provide the frame constructor with respective control signals/data 23c indicative thereof. A frame partitioning module 26t can be used in the control unit 26 for determining sizes of the various fields of the constructed payload-frames. For example, and without being limiting, a different size can be determined for the tag field 23a of different payload-frames constructed by different frame constructing components 23u, and/or by the same constructing component 23u, according to the number of bits required for the downlink communication information/tag(s). More particularly, if the end-user(s) to which a constructed payload-frame is destined can be directly communicated by the payload system PLₘ, then a fixed size tag field 23a can be used in such payload-frames, and in case one or more other payload systems should be involved in the communication of the payload-frame to its destination the size of the tag field 23a can be dynamically varied to accommodate the number of bits required at the frame construction stage, and thereafter as the frame is forwarded from one payload system to another.

In some embodiments the control unit 26, and/or the frame partitioning module, utilizes a signal-to-noise (SNR) table 28 periodically/intermittently updated with data about the SNR conditions over each uplink channel ULₙ and each downlink channel DLₖ. Based on these SNR conditions the system can determine the error correction codes to use in each uplink channel ULₙ, and in each downlink channel DLₖ, and properties of each error correction code. In some embodiments, the SNR conditions are used to determine the code rate of the error correction in each uplink and downlink channel. Based on the determined code rates the frame partitioning module 26t of the control unit 26 can determine for each frame constructing components 23u a size of the U_{FEC} field 23f suitable for accommodating the error correction data the frame need to carry in the uplink and in the downlink communications, which can be conveyed to the frame constructor 23 within the signal/data 23c.

In some embodiments the signals/data 21c the control unit 26 communicates with the buffering unit 21 is used to indicate if one or more of the buffers Bufferₖ became empty i.e., if data packets are not communicated to certain end-user(s) over some period of time. If one or more of the buffers Bufferₖ are empty there is no data for frame construction by the respective frame constructing component 23u, and in this case the control unit 26 can instruct the respective frame constructing component 23u to construct dummy frames, until communication traffic to the respective certain end-user(s) is renewed (i.e., until the empty buffer is filled again with packet data). The dummy frames may contain known symbols or arbitrary data, and carry no valuable information.

The dummy frames constructed by the frame constructor 23 are forwarded to scheduler 24 to schedule their transmission to the payload system PL like the regular data payload-frames. In this way the gateway system 20 can fill transmission gaps that may occur for any reason when there is no data to send to any of the ports/beams of the payload system PLₘ.

A scheduler module 26s can be used in the control unit 26 for generating signals/data 24c for orchestrating the operation of the scheduler 24. The scheduler module 26s can be configured to monitor the amount of communication traffic the gateway system 20 needs to transfer via each communication port/beam BMₖ of the payload system PLₘ, and accordingly generate control signals/data 24c for the scheduler 24 to determine frame dispatch timings that will prevent congestions at the different payload ports/beams BMₖ.

In regenerative payload systems the gateway-link/uplink ULₙ and the target-link/downlink DLₖ may have different bandwidths and different modulation and coding properties (MODCOD). Thus, in some embodiments, the scheduler module 26s of the control unit 26 can be configured to monitor the frame communication rate (GWrate) expected over the uplink ULₙ of the gateway system 20, and the frame communication rate (BMrateₖ) expected in each payload port/beam BMₖ, and accordingly generate data/instructions 24c for operating the scheduler 24 to prevent traffic congestions at any of the payload port/beam BMₖ. In some embodiments the scheduler module 26s is configured to guarantee that the following condition is continuously satisfied—

$$GWrate \leq {\sum }_{k = 1}^{K} {BMrate}_{k} ,$$

and thereby ensure that there are no queues and congestion management needed in the payload system PLₘ. The instructions 24c to the scheduler 24 can be used to determine timing and/or rates of combining dummy frames to one or more payload ports/beams BMₖ in the stream of frames communicated by the gateway system 20 over the uplink channel ULₙ. The scheduler module 26s of the control unit 26 can be configured to determine a rate of combining the dummy payload-frames in the stream of frames transmitted over the uplink ULₙ for guaranteeing that the amount of real/non-dummy payload-frames continuously sent in the uplink ULₙ to each port/beam BMₖ satisfies the ratio THROUGPUT(ULₙ)/THROUGPUT(BMₖ), where THROUGPUT(ULₙ) is the throughput of the uplink channel ULₙ and THROUGPUT(BMₖ) is the throughput of the downlink port/beam BMₖ. The throughput of each channel can be determined by multiplying the bandwidth (in Hz) of the channel by the modulation efficiency measured in bits/Hz.

This payload-frames construction scheme of the gateway system 20, which initially determines the sizes of the data field 23d, and/or of the tag field 23a, and/or of the error correction data fields, U_{FEC} 23f and pad 23p, based on uplink and/or downlink SNR conditions, and/or the number of payload relays that will be needed for the payload-frame to reach its destined end-user(s), substantially reduces the operations required at the payload system(s) PLₘ to the following actions:
demodulation and decoding of the incoming signal for extracting the bits of transmitted payload-frames;
read and remove at least one of the downlink communication information/tag(s) obtained in the tag field 23a of each payload-frame;
forward the frame to the destination beam/port BMₖ indicated in the downlink communication information/tag(s) read/removed from the frame; and
encode, modulate and transmit, the frames according to the downlink communication information/tag(s) read/removed from the frame.

The removal of downlink communication information/tag(s) from the frame, and replacing the uplink error correction data and the optional reserved padded bits, with the downlink error correction data (i.e., placing the downlink error correction data in the U_{FEC} and pad fields, 23f and 23p, respectively), is referred to herein as conversion of a payload-frame into a user-frame in case the frame can be transmitted by the payload system directly to the end-user(s). As demonstrated in FIG. 2B, this technique enables very small payload systems implementations. The demodulators of demodulation unit 11 of the payload systems PLₘ are accordingly configured to ignore/discard the dummy frames receive from the gateway systems GWₙ over their respective uplink channels ULₙ.

FIG. 3B schematically illustrates a scheduler unit 24 embodiment comprising a control unit 24r and a multiplexer (Mux) 24x configured to select one payload-frame from a plurality of payload-frames on its input ports, and output the selected payload-frame for transmission based on control signals mx generated by the control unit 24r. The payload-frames at the inputs of the multiplexer 24x include the data frames, PF for BMₖ, constructed by the frame constructing component 23u of the frame constructor 23, each of which may include either a data payload-frame or dummy frame.

The control unit 24r is configured and operable to receive the control signals/data 24c from the control unit 26 of the gateway system 20, and/or SLA (service level agreement) data of each end-user(s), and/or the uplink and downlink throughputs data UDTD of the uplink channel ULₙ and of each beam/port BMₖ of the payload system PLₘ, and determine at least partially based thereon the control signals mx for the multiplexer 24x. Based on the received signals/data the control unit 24r determines the next data frame PF for BMₖ to be transmitted to one of the ports/beams of the payload system PLₘ, and accordingly generates the control signals mx. The control unit 24r is configured in some embodiments to process the received signals/data to determine accordingly the sequence of payload-frames that will be transmitted from the gateway 20 to the different ports/beams BMₖ of the payload system PLₘ.

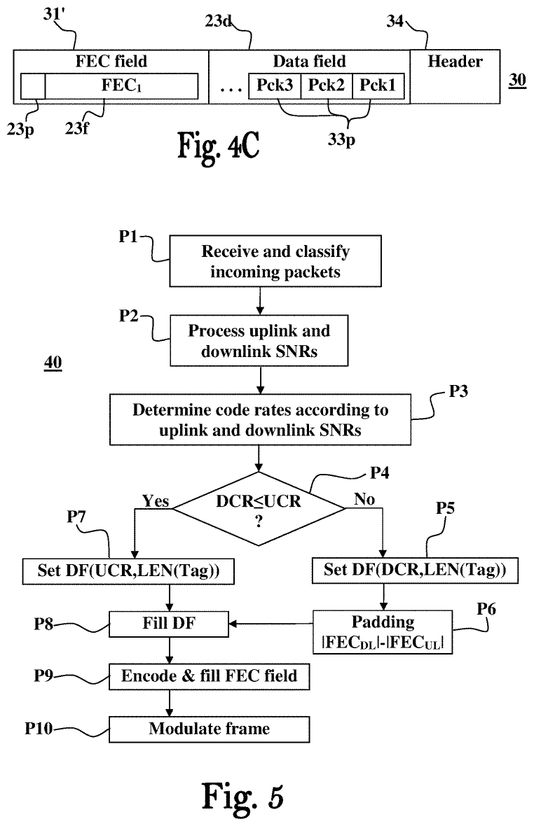

FIG. 4A schematically illustrates a possible structure of payload-frame 30. In this specific and non-limiting example the frame 30 comprises a header 34 constructed according to the specific communication standard/protocol being used in the uplink ULₙ, the data field 23d comprising one or more data packets 33p or fragments thereof, the tag field 23a comprising one or more downlink communication information/tag(s) 32t, and a data correction code field (FEC) 31, the FEC field, comprising the uplink error correction data (FEC_{UL}) 23f, and optionally padded bits 23p reserved for allowing accommodation of the downlink error correction data in the payload-frame in case a smaller code rate is to be used in the downlink and/or in the forwarding of the frame to one or more other payload systems.

FIG. 4B illustrates a payload-frame 30 after removal of one downlink communication information/tag from the tag field 23a, as may occur if a chain of two or more payload system are required for transmitting the frame to its destined end-user(s). In these situations, the error correction data field 31′ can be adapted to include the bits formerly used to hold the downlink communication information/tag that has been removed from the tag field 23a, in addition to (or instead of) the bits of the original FEC field 31. This means that in certain situations the gateway system will not be required to reserve the padded bits 23p, even if the code rates required after transmittal of the frame in the uplink are smaller, as the space freed by the removal of downlink communication information/tag can provide the extra space required for the error correction data of the code rates expected further on along the transmission path.

FIG. 4C illustrates a payload-frame 30 after all of the downlink communication information/tags are removed from the frame, such that the tag field 23a is no longer required, and thus removed altogether, from the frame. As seen, the error correction data field 31′ can be modified to include all, or part, of the space/bits formerly used for the tag field 23a. In this case the payload-frame is to be sent directly to the end-user(s), and it can be easily converted into a user-frame by filling into the error correction data field 31′ the downlink error correction data 23f.

FIG. 5 is a flowchart of a payload-frame construction process 40 according to some possible embodiments. The process 40 starts in step P1 wherein the data packets are received and processed in the gateway system (20), and each received data packet is classified/sorted according to its destination IP address into respective buffers (BUFFERₖ) associated with a communication port/beam of the payload system (PLₘ). In step P2 the SNRs of the uplink (ULₙ) and of the downlinks (DLₖ) are processed for determining in step P3 the code rates to be used in the uplink (ULₙ) and the downlinks (DLₖ). Step P4 checks for each downlink (DLₖ) if the downlink code rate (DCR) is smaller or equal to the uplink code rate of (UCR).

If it is determined in step P4 that the DCR is smaller than, or equal to, the UCR, then in step P7 the size of the data field (DF, 23d) is determined based on the number of bits required for the error correction data of the UCR and the number of bits required for the downlink communication instructions/tag(s), and thereafter in step P8. the amount of packet data the DF can accommodate is fetched from the respective buffer (BUFFERₖ) and placed in the DF.

If it is determined in step P4 that the DCR is greater than the UCR, then in step P5 the size of the data field (DF, 23d) is determined based on the number of bits required for the error correction data of the DCR and the number of bits required for the downlink communication instructions/tag(s). In step P6 padding is performed to reserve space in the frame for the downlink error correction code data, and thereafter in step P8, the amount of packet data the DF can accommodate is fetched from the respective buffer (BUFFERₖ) and placed in the DF. Optionally, and in some embodiments preferably, the amount of reserved padded bits is determined according to the difference between the number of bits required for the downlink error correction code data (|FEC_{DL}|) and the number of bits required for the uplink error correction code data (|FEC_{UL}|).

In step P9 the payload-frame is encoded and the error correction data field (31) is at least partially filled with the uplink error correction code data. Next, in step P10, the payload-frame is modulated for transmission to the payload system over the uplink (ULₙ).

### Example 1

As described hereinabove, in some embodiments the gateway system (20) is configured to ensure that the amount of information bits (i.e., packet(s) data bit) in each baseband payload-frame complies with the amount of error correction bits required by the downlink code rates (MODCOD). For example, if the downlink code rate is 2/3, then in some embodiments the gateway uses the same code rate (i.e., 2/3), or a lower code rate, to guarantee that there is sufficient space to send all information bits arriving from the gateway when the frame is transmitted over the downlink channel. If for some reason the uplink channel is using a higher code rate, for example 9/10, then the payload-frame should have enough padding bits reserved.

Accordingly, if the size of the baseband payload-frame is 64800 bits, then for a downlink code rate of 2/3 the amount of information bits available in the frame is 64800*2/3=43200. Thus, in case of 9/10 code rate is used in the uplink, the upload baseband payload-frame has 64800*9/10=58320 information bits, which means that 58320−43200=15120 bits should be reserved by padding in the payload-frame for leaving enough space in the frame for the downlink error correction code data when it is transmitted over the downlink/user link.

Generally, the control unit (16) of the payload system can be very flexible in the number of ports/beams (BMₖ) it serves, in terms of the bandwidth and center frequency used in each communication port/beam. However, in some embodiments, it is assumed that a fixed configuration is used in each payload system (PLₘ). Even if these properties are changed over the air occasionally, such changes typically don't occur so often, and it is thus still assumed to be fixed configuration.

On the other hand, there is information that the payload system must have per each payload-frame. Mainly, the communication port/beam, and the error correction parameters (MODCOD), to be used when forwarding the frame. As demonstrated herein above, this information can be embedded into the baseband payload-frames as proprietary tags/instructions in the tag field (23a). In some embodiments, each tag represents an entry in a lookup table (LUT) maintained at the payload system. The LUT can be refreshed from time to time e.g., by information provided over a control channel. For LEO satellite constellations where the payload-frames may be forwarded through an ISL, it is possible to embed two or more sets of tags into the payload-frame. Where the first set of tags describes the transmission over the ISL, and the second set of tags describes the port/beam for the downlink/target user link.

### Example 2

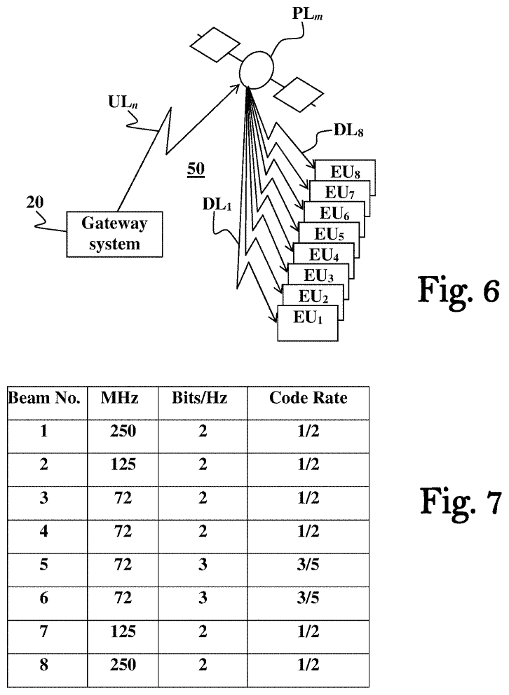

Possible embodiments will be exemplified hereinbelow for a regenerative satellite payload system 50 having a gateway system 20 configured to serve eight user groups, EU₁, EU₂, . . . , EU₈, via a payload satellite system PLₘ that have eight communication beams, DL₁, DL₂, . . . , DL₈, each of which illuminates a respective one of the user groups EUᵢ (where 1≤i≤8 is an integer) and different users within the different groups, as illustrated in FIG. 6. The gateway system 20 can be configured to transmit in an uplink channel using 32-APSK modulation and a 500 MHz bandwidth that gives 5 bits/Hz throughput and a code rate of 3/4. The gateway 20 may be configured to send the communication traffic to the eight end-users EUᵢ over their respective beams DLᵢ, as defined in the table shown in FIG. 7.

In the gateway system 20 data packets are gathered and aggregated into baseband payload-frames, as described hereinabove with reference to FIGS. 2 to 4. Typically, each user group EUᵢ have a dedicated frame construction process (23u) configured to compose the baseband payload-frames for the respective communication beam DLᵢ that serve the user group. Each of the constructed baseband payload-frames contains information indicative of the code rate to be used at the target respective beam DLᵢ. In this specific and non-limiting example the baseband payload-frames constructed for beams DL₁, DL₂, DL₃, DL₄, DL₇ and DL₈, have a code rate of V, and therefore capable of carrying 64800*1/2=32400 data packet information bits, and the baseband payload-frames constructed for beams DL₅ and DL₆, have a code rate of 3/5.

All of the communication beams DU can have code rates that are lower than the code rate of the uplink ULₙ of the gateway system 20, and thus the gateway system 20 can drop the rate and use a code rate of 1/2 for baseband payload-frames targeting the communication beams DL₁, DL₂, DL₃, DL₄, DL₇ and DL₈, and a code rate of 3/5 for the baseband payload-frames targeting the communication beams DL₅ and DL₆, or alternatively embed padding reserved bits in the baseband payload-frames by each of the frame construction process (23u). In such alternative scenario the respective frame construction processes need to reserve 16200 padding bits in the baseband payload-frames targeting beams DL₁, DL₂, DL₃, DL₄, DL₇ and DL₈, and to reserve 9720 padding bits for the baseband payload-frames targeting beams DL₅ and DL₆.

In certain situations the gateway system 20 may drop the code rate over the uplink ULₙ below the 3/5 code rate (e.g., due to deterioration of the SNR conditions in the uplink ULₙ). In this case, in order to prevent the payload-frames construction processes of the user groups DL₅ and DL₆ from constructing baseband payload-frames having a data field (23d) which size is greater than the data field size that the uplink payload-frames can actually accommodate, the gateway system 20 is configured to adapt the frame construction processes to limit the sizes of data fields of the constructed baseband payload-frames to comply with the code rate used in the uplink ULₙ.

In addition, as the downlink communication information/tag(s) added by the gateway system in each constructed payload-frame, for switching and modulating the payload-frames at the payload system, can be of different lengths for each of the communication beams of the payload system, which can also change over time (e.g., in LEO constellation systems where satellites move and the path to get to a user group changes over time), for practical implementations, a fixed upper bound value may be defined in possible embodiments for limiting the size of the tag fields (23a) allocated by payload-frames construction processes from exceeding a predefined size. The control unit (26) of the gateway system can be configured to provide this information to the payload-frames construction processes (23u), in order to guarantee that enough bits are reserved for the tag field (23a) to allow adding the downlink communication information/tag(s) to each of the payload-frames thereby constructed.

### Example 3

As described hereinabove, the gateway system 20 can be configured to verify for each payload-frame thereby constructed that the number of bits required for the downlink communication information/tag(s) and for the error correction data leaves enough space for the packet(s) data to be placed in the data field (23d), as follows:

#Data-Bits≤LEN(PLF)×MIN(UPcode-rate,DOWNcode-rate)−LEN(Tag)

In this specific and non-limiting example, the total throughput of the uplink ULₙ is 2500 Mbps, while the total throughput required by all the downlinks DLₖ is 2220 Mbps. In this configuration the gateway system is configured to combine in the stream of payload-frames transmitted to the different target communication ports/beams dummy frames to prevent overflow. For example, if the throughput of beam DL₆ is 216 Mbps, to prevent overflow the gateway system is configured to send a payload (dummy or real data) frame to the beam DL not more than every 11.58 (≈2500/216) frames in average. This rate adaptation can be achieved by means of a smart arbitration scheme between all of the payload-frames construction processes for each user group EUᵢ, configured to select which process to serve according to its throughput.

It is noted that generally there is no problem when the amount of payload-frames sent to the target ports/beams is smaller than the maximal throughput of each port/beam. In such cases the respective modulator of the port/beam automatically creates a dummy frame to fill the gap. Accordingly, the modulator Modₖ at each beam/port BMₖ of the payload system can automatically generate dummy frames when there is nothing else to transmit thereby.

The payload system is implemented in some embodiments by a plurality of interconnected units configured and operable to communicate the payload-frames therebetween. For example, if the payload system comprises a number of devices, where the term device is a general term referring to a circuit board or to a component on a circuit board, which is an element of the payload system, since the number of modulators and demodulators one can implement in a single device is very limited, multiple devices can be connected to each other using an expansion port. The entire decoded baseband payload-frame, carrying the downlink communication information/tag(s) inside, can be encapsulated (e.g., by the switch device 13) in an Ethernet packet (e.g., using jumbo packets i.e., packets exceeding the standard maximum packet transmission size), or any other protocol of transferring packets between devices, and sent over the expansion port for switching to the respective beam port BMₖ. The expansion port can be configured to use regular Ethernet physical protocol, or use a SerDes (serializer/deserializer) technology, or any other physical technology suitable to communicate between such devices.

In this way, different devices can be connected on the same PCB (printed circuit board) using the SerDes, or to devices implemented on different interconnected PCBs (e.g., by a connector). Alternatively, an Ethernet physical layer circuitry (PHY) can be used to transfer the data over a cable to another PCB which is not physically attached by connectors to a chassis/backplane board typically used to facilitate the connectivity between the boards. In this way, by using PHY device(s) and cable(s), or optic fiber(s), the different PCBs can be separated from one another.

Using a common protocol like Ethernet gives flexibility in the system design as it supports multiple data rates and multiple configurations. The different devices can be interconnected to carry out the frame switching using one or more topologies, such as, but not limited to, ring, mesh, dual dimension ring or even a star topology using a layer 2 Ethernet switch. In each device a forwarding lookup table can be used to indicate how to send each payload-frame arriving from the gateway system. One of the decisions that can be made based on forwarding lookup table can be whether to forward payload-frames from the device via an expansion port, and which information to include in the headers of the Ethernet packets encapsulating the payload-frames i.e., information of the target device of the payload-frame. Payload-frames arriving from the expansion port can go through the same lookup process to decide on their targets, which may be either another expansion port (ring topologies for example) or whether it should be sent over one of the local modulators i.e., to end-user(s).

In this configuration complete payload-frames can be switched and forwarded based on information that is predefined and embedded thereinside as tag(s). The only difference is the physical medium used for communicating the payload-frames between the devices.

The return channel of the payload systems disclosed herein can work mutatis mutandis using the same principles with a few small modifications. Multiple user links can be aggregated together and send to the gateway system gateway-frames over the gateway link. The return gateway link can use in some embodiment the S2X protocol, and the user link may work in RCS2 or similar protocol. On each user return beam, multiple terminals communication traffic using frequency and time multiplexing on a slot allocated by the gateway, can be used. The control unit 16 of the payload system can be configured to use the devices of the payload system to decode the gateway-frames received over the user channels, and to forward/switch the received gateway-frames to the gateway beam. Since many of the user return traffic are short frames, multiple frames can be aggregated together at the payload system onto a single baseband gateway-frame that is sent to the gateway. In LEO constellations, the same scheme can be used, but modified for transmission over the ISL in the same manner rather to the gateway system.

When forwarding the frame from the ISL to the gateway system, it can be performed in some embodiments the same way as in the forward channel. Since the gateway system controls the slot allocation to the users it can assure it will not overflow the return gateway link.

In the embodiments disclosed herein control information can be transferred back and forth. The payload system can be configured to use the control information communicated with the gateway system to exchange SNR information, refresh forwarding tables, and provide error reports and general statistics. The control information can be transferred in-band. This means that some of the baseband frames received at the payload system are not forwarded to any target user beam but to the internal control unit. It is also possible to transfer in some embodiments the control frames over the expansion port to another device the same way it transfers other payload-frames. The forwarding of the payload-frames between the devices on each satellite system, and/or over ISL (if is not RF based), can be carried out using regular Ethernet packets.

It is noted that embodiments disclosed herein support use of different bandwidths, different modulation schemes and code rates, in each of the downlinks DU of the payload system, which is achieved in some embodiments by embedding in the tag field added by the gateway system 20 information about the required modulation for each payload-frame to be sent over each downlink link. As described hereinabove, the same techniques can be similarly used in the return channel of the payload system.

In some embodiments received RCS2 packets are forwarded by the system over DVB-S2X links. Optionally, and in some embodiment preferably, small return channel over satellite (RCS) packets are aggregated into bigger S2X baseband frames. Performance is optimized in some embodiments by exchanging between the gateway and payload systems control information, including information about SNR conditions in the different uplink(s) and downlinks. A dedicated side control channel is used in some embodiments to exchange the control information. Alternatively, the control information can be exchanged inline using the “forwarding device” as source or destination end terminals.

It is noted that the embodiments disclosed herein can be used in various different types of payload systems, such as, but not limited to, UAV (unmanned aerial vehicle) systems, HALE (high altitude/long endurance) systems, balloons (e.g., hot air balloons), and any combination thereof, and/or any system that uses the S2X and/or RCS2 communication protocols.

It should be understood that throughout this disclosure, where a process or method is shown or described, the steps of the method may be performed in any order or simultaneously, unless it is clear from the context that one step depends on another being performed first.

As can be understood from the disclosed embodiments, functions of the systems described hereinabove may be controlled through instructions executed by a computer-based control system. A control system suitable for use with embodiments described hereinabove may include, for example, one or more processors connected to a communication bus, one or more volatile memories (e.g., random access memory—RAM) or non-volatile memories (e.g., Flash memory). A secondary memory (e.g., a hard disk drive, a removable storage drive, and/or removable memory chip such as an EPROM, PROM or Flash memory) may be used for storing data, computer programs or other instructions, to be loaded into the computer system.

For example, computer programs (e.g., computer control logic) may be loaded from the secondary memory into a main memory for execution by one or more processors of the control system/units. Alternatively or additionally, computer programs may be received via a communication interface. Such computer programs, when executed, enable the computer system to perform certain features of the present invention as discussed hereinabove. In particular, the computer programs, when executed, enable a control processor to perform and/or cause the performance of features of the present invention. Accordingly, such computer programs may implement controllers of the computer system.

In an embodiment where the invention is implemented using software, the software can be stored in a computer program product and loaded into the computer system using the removable storage drive, the memory chips or the communications interface. The control logic (software), when executed by a control processor, causes the control processor to perform certain functions of the invention as described herein.

In other possible embodiments, features of the invention are implemented primarily in hardware using, for example, hardware components such as application specific integrated circuits (ASICs) or field-programmable gated arrays (FPGAs). Implementation of the hardware state machine so as to perform the functions described herein will be apparent to persons skilled in the relevant art(s). In yet another embodiment, features of the invention can be implemented using a combination of both hardware and software.

As described hereinabove and shown in the associated figures, the present invention provides regenerative payload communication systems and related methods. While particular embodiments of the invention have been described, it will be understood, however, that the invention is not limited thereto, since modifications may be made by those skilled in the art, particularly in light of the foregoing teachings. As will be appreciated by the skilled person, the invention can be carried out in a great variety of ways, employing more than one technique from those described above, all without exceeding the scope of the claims.

1. A gateway system comprising:
a classification component configured to classify a stream of data packets received by the gateway system into a plurality of groups based on destination tags embedded in said data packets, each of said groups associated with a respective communication port of a payload system; and
a frame constructor for forming respective payload-frames for each group of classified data packets, said frame constructor configured to determine for the respective payload-frames of each of said plurality of groups an amount of the classified data packets based at least in part on communication link conditions associated with the respective communication port of the group, so as to guarantee that said respective payload-frames can accommodate error correction data to be inserted thereinto by said payload system for transmitting them via said respective communication port, and construct said respective payload-frames to comprise the determined amount of data of the classified data packets and target information indicative of at least the respective communication port associated with said classified data packets.

2. The system of claim 1 wherein the frame constructor is configured and operable to construct one or more dummy frames during time periods in which communication of data packets associated with one or more of the communication ports of the payload system is stopped.

3. The system of claim 1 comprising a control unit configured and operable to determine a size of a data field of the respective payload-frames based at least in part on conditions in a communication link between the gateway and the payload system.

4. The system of claim 3 wherein the control unit of the gateway system is configured and operable to determine a size of an error correction data field of the respective payload-frames based at least in part on the communication link conditions.

5. The system of claim 4 wherein the control unit of the gateway system is configured and operable to reserve a portion of the error correction data field for error correction code data associated with the respective communication port of the payload system.

6. (canceled)

7. The system of claim 1 wherein the control unit of the gateway system is configured and operable to determine at least one of a code rate and modulation properties for transmission by the gateway system based at least in part on the communication link conditions.

8. A regenerative communication system comprising:
a gateway system according to claim 1; and
a payload system comprising a receiver configured to receive the respective payload-frames transmitted from the gateway system, and a switching component configured to direct the received respective payload-frames to the respective communication port of the payload system based on the target information contained therein.

9. (canceled)

10. The system of claim 8 wherein the payload system comprises a communication component configured to transmit each received respective payload-frame via its respective communication port, and wherein the control unit of the gateway system is configured to determine at least one of a code rate and modulation properties used by the communication component of the payload system to transmit the payload-frames.

11. The system of claim 8 wherein the payload system is configured and operable to transform one or more of the respective payload-frames received from the gateway system into user-frames by placing in the error correction code data field of each of said respective payload-frames error correction code data associated with the respective communication port and removing at least a portion of the target information associated with said respective communication port.

12. The system of claim 8 wherein transmission from the payload system is different from the transmission from the gateway system by at least one of modulation scheme, coding scheme, a center frequency, and a frequency band.

13. (canceled)

14. The system of claim 8 wherein the gateway system comprises a scheduler configured and operable to determine a sequence of the respective payload-frames for transmission to the payload system based at least in part on a service level agreement of at least one end-user associated with one of the communication ports and/or a throughput of at least one of the communication ports.

15-16. (canceled)

17. The system of claim 8 wherein the gateway system comprises a scheduler is configured and operable to guarantee that a transmission rate of the payload-frames from the gateway system is smaller than, or equal to, a total frame transmission rate from all of communication ports of the payload system.

18. The system of claim 1 wherein the payload system is either a terrestrial craft, celestial craft, aircraft, air/gas balloon, satellite, missile, air or space shuttle or space craft.

19. (canceled)

20. The system of claim 1 wherein the communication link conditions comprises at least one of SNR, bandwidth, modulation scheme or coding scheme.

21. A method of forwarding data packets, the method comprising:
classifying a stream of data packets into a plurality of groups based on destination tags embedded in said data packets, each of said groups associated with a respective communication port of a payload system;
for each of said groups determining an amount of the classified data packets carried by respective payload-frames based at least in part on communication link conditions associated with the respective communication port of said group, so as to guarantee that said respective payload-frames can accommodate error correction data to be inserted thereinto by said payload system; and
constructing the respective payload-frames to comprise the determined amount of the classified data packets and target information indicative of at least the respective communication port associated with said classified data packets.

22. The method of claim 21 comprising constructing one or more dummy frames during time periods in which communication of data packets associated with one or more of the communication ports of the payload system is stopped.

23. The method of claim 21 comprising determining a size of a data field of each of the respective payload-frames based at least in part on communication link conditions in a communication channel associated with the payload system.

24. The method of claim 23 comprising determining a size of an error correction data field of the respective payload-frames based at least in part on the communication link conditions.

25. The method of claim 24 comprising reserving a portion of the error correction data field for error correction code data associated with the respective communication port of the payload system.

26. The method of claim 21 comprising transmitting the payload-frames to the respective payload system and determining at least one of a code rate and modulation properties for the transmission to the payload system based at least in part on the communication link conditions.

27. (canceled)

28. The method of claim 26 comprising receiving the respective payload-frames at the payload system, directing each of the received respective payload-frames to the respective communication port of the payload system based on the target information contained therein, and transmitting each of the received respective payload-frames via its respective communication port.

29-30. (canceled)

31. The method of claim 28 comprising a least one of the following: determining at least one of a code rate and modulation properties used for the transmitting via the respective communication port; placing in the error correction code data field of the respective payload-frames error correction code data associated with the respective communication port; and removing from the error correction code data field of the respective payload-frames at least a portion of the target information associated with said respective communication port.

32. (canceled)

33. The method of claim 21 comprising determining a sequence of the respective payload-frames for transmission to the payload system based at least in part on a service level agreement of at least one end-user associated with one of the communication ports or a throughput of at least one of the communication ports.

34. (canceled)

35. The method of claim 33 wherein the determining of the sequence of the respective payload-frames comprises guaranteeing that a transmission rate of the payload-frames to the payload system is smaller than, or equal to, a total frame transmission rate from all of communication ports of the payload system.

36. (canceled)
